(19) United States
(12) Patent Application Publication
(10) Pub. No.: US 2002/0104220 A1
(43) Pub. Date: Aug. 8, 2002

(54) Hidden trigger double action folding knives

(76) Inventor: Anthony L. Marfione, Vero Beach, FL (US)

Correspondence Address: MR. ANTHONY MARFIONE, 4865 12TH PLACE, VERO BEACH, FL, 32960, US

(21) Appl. No.: 09/773,465

(22) Filed: Feb. 2, 2001

(51) Int. Cl. B26B 1/02

(52) U.S. Cl. 30/160; 30/161

(57) ABSTRACT

Folding knives of the double action type in which a pivoted blade can be moved from the sheathed position within the handle and lock automatically in the unsheathed use position in two different ways at the option of the user, namely, (a) to snap the blade into the use position via spring action by movement of a release trigger or (b) to silently unfold the blade manually into the use position, are improved by providing the knives with hidden release triggers, i.e., triggers that are not apparent to viewers in normal inspection of the knives. A unique form of trigger release is disclosed.

### BACKGROUND OF THE INVENTION

1. Field of the Invention

This application relates broadly to folding knives that have a blade pivoted at one end to fold into a sheath handle. More particularly, it concerns such knives that are of the double action type and which have a hidden trigger for automatic release of the blade from the handle to move and lock in the use position.

2. Description of the Prior Art

Double action folding knives are a known class in which the pivoted blade can be moved from the sheathed position within the handle and lock automatically in the unsheathed use position in one of two ways at the option of the user (see U.S. Pat. No. 5,819,414). Thus, the user may choose (a) to snap the blade into the use position via spring action by manipulating a release trigger or (b) to silently unfold the blade manually into the use position.

The double action folding knives were preceded by many versions of single action folding knives that lock a pivoted blade in the use position upon manual movement from a sheathed position to a use position (see U.S. Pat. Nos. 4,837,932, 5,502,895, 5,511,310, 5,694,692, 5,737,841, 5,755,035, 5,875,552 and 5,964,035).

Moreover, forms of single action folding knives are known that use trigger means, rather than manual movement, to move the blade from a sheathed position within the handle into the use position (see U.S. Pat. Nos. 4,811,486, 5,331,741 and 5,822,866).

### OBJECTS

A principal object of the invention is the provision of improved folding knives of the double action class, namely, that enable the user to move the blade from its sheathed position to locked use position in two different ways, i.e., manual movement and spring means movement.

Another object is the provision of improved double action folding knives that have a hidden trigger, i.e., triggers that are not apparent to viewers in normal inspection of the knives.

A further object is the provision of improved double action folding knives that enable a snap action means to remain cocked when the blade is manually unsheathed, i.e., moved simply by hand into its use position.

Other objects and further scope of applicability of the present invention will become apparent from the detailed descriptions given herein; it should be understood, however, that the detailed descriptions, while indicating preferred embodiments of the invention, are given by way of illustration only, since various changes and modifications within the spirit and scope of the invention will become apparent from such descriptions.

### SUMMARY OF THE INVENTION

The stated objects are accomplished in accordance with the invention by the provision of a double action folding knife comprising a longitudinal sheath handle, a blade that pivots about one end from a sheathed position within the handle to a use position external of the handle, spring means to rotate the blade from the sheathed position into the use position and hidden trigger means for automatic movement of the blade from the sheathed position to lock in the use position.

The longitudinal sheath handle has a first end, a second end and a channeled body portion integrally joining the first and second ends.

The blade has a pivot end, a free end and an integral central body portion all lying in a common plane. The pivot end is pivoted to the handle first end about an axis normal to the common plane enabling the blade to move between the sheathed position within the handle through an arc to the use position external of the handle.

Pivot means upon which the blade is pivoted enables the blade to be manually moved between the sheathed position and the use position.

The knife handle is constructed of an assembly, in turn from its right hand side to its left hand side, of a right bolster and right scale as a first layer, a right liner as a second layer, the blade, a leaf spring and a spacer spine as a third layer, a left liner as a fourth layer, a left bolster and left scale as a fifth layer.

There is lock means to automatically lock the blade in the use position upon completion of the movement thereof into the use position and to be manually unlocked for manual return of the blade from the use position to the sheathed position.

Further, there is spring means that is cocked by manual rotation of the blade from the use position to the sheathed position and can be uncocked for automatic rotation of the blade by such spring means forcibly from the sheathed position to the use position.

Additionally, there is hidden trigger means that holds the spring means in its cocked mode and un-cocks the spring means for automatic blade rotation when manipulated by the user of the knife.

In preferred embodiments of the invention, the hidden trigger means comprises a bolster that is pivoted to reciprocate in a plane parallel to the common plane between a spring cocked position and a spring un-cocking position, a cavity in the right hand bolster, a catch fixed in the cavity and a sear that engages the catch when the blade is returned to the sheathed position and disengages from the catch when the right hand bolster is moved into its spring un-cocked position.

The new knives may include a belt clip, a lanyard, scale engravings or ridges and like embellishments know to the art.

### BRIEF DESCRIPTION OF THE DRAWINGS

A more complete understanding of the invention can be obtained by reference to the accompanying drawings of an embodiment of a knife in accordance with the invention in which:

FIG. 1 is an exploded isometric view of the knife.

FIG. 2 is side view of the left hand side of the knife with the blade in the opened use position. In the knife art, the left hand side of a knife means that side which a viewer sees when the knife is held in the left hand with the blade edge pointing downward.

FIG. 3 is the left side view of the knife with the blade in the closed sheathed position.

FIG. 4 is side view of the right hand side of the knife with the blade in the opened use position. In the knife art, the right hand side of a knife means that side which a viewer sees when the knife is held in the right hand with the blade edge pointing downward.

FIG. 5 is the right hand side view of the knife with the blade in the closed sheathed position.

FIG. 6 is a plan view of the outside of the left scale of the knife.

FIG. 7 is a plan view of the inside of the left scale of the knife.

FIG. 8 is a plan view of the outside of the right scale of the knife.

FIG. 9 is a plan view of the inside of the right bolster of the knife.

FIG. 10 is a plan view of the outside of the left bolster of the knife.

FIG. 11 is a plan view of the inside of the left bolster of the knife.

FIG. 12 is a plan view of the outside of the right bolster of the knife.

FIG. 13 is a plan view of the inside of the right bolster of the knife.

FIG. 14 is a plan view of the outer side of the left liner of the knife.

FIG. 15 is a plan view of the inner side of the left liner of the knife.

FIG. 16 is a plan view of the outer side of the right liner of the knife.

FIG. 17 is a plan view of the inner side of the right liner of the knife.

FIG. 18 is a lateral view of a pin spine of the knife.

FIG. 19 is a lateral view of the blade bushing of the knife.

FIG. 20 is an end view of the blade pin of the knife.

FIG. 21 is a lateral view of a blade pin of the knife.

FIG. 22 is a lateral view of the spring retainer pin of the knife.

FIG. 23 is a lateral view of the male stud of the knife.

FIG. 24 is an end view of the male stud of the knife.

FIG. 25 is a lateral view of the female part of the stud of the knife.

FIG. 26 is an end view of the male part of the stud.

FIG. 27 is an end view of the sear of the knife.

FIG. 28 is a lateral view of the sear of the knife.

FIG. 29 is a lateral view of the blade stop pin of the knife.

FIG. 30 is a lateral view of the un-notched side of the trigger catch of the knife.

FIG. 31 is a side view of the trigger catch of the knife.

FIG. 32 is a lateral view of notched side of the trigger catch of the knife.

FIG. 33 is a plan view of the small blade washer of the knife.

FIG. 34 is a lateral view of the left spring of the knife.

FIG. 35 is a plan view of the large blade washer of the knife.

FIG. 36 is a lateral view of the spacer spine of the knife.

FIG. 37 is a view like right hand view FIG. 4 with the right bolster and right liner removed.

FIG. 38 is a view like right hand FIG. 5 with the right bolster and right liner removed.

FIG. 39 is a view of the inner side of the right bolster and a portion of the trigger means associated therewith.

### DESCRIPTION OF THE PREFERRED EMBODIMENTS

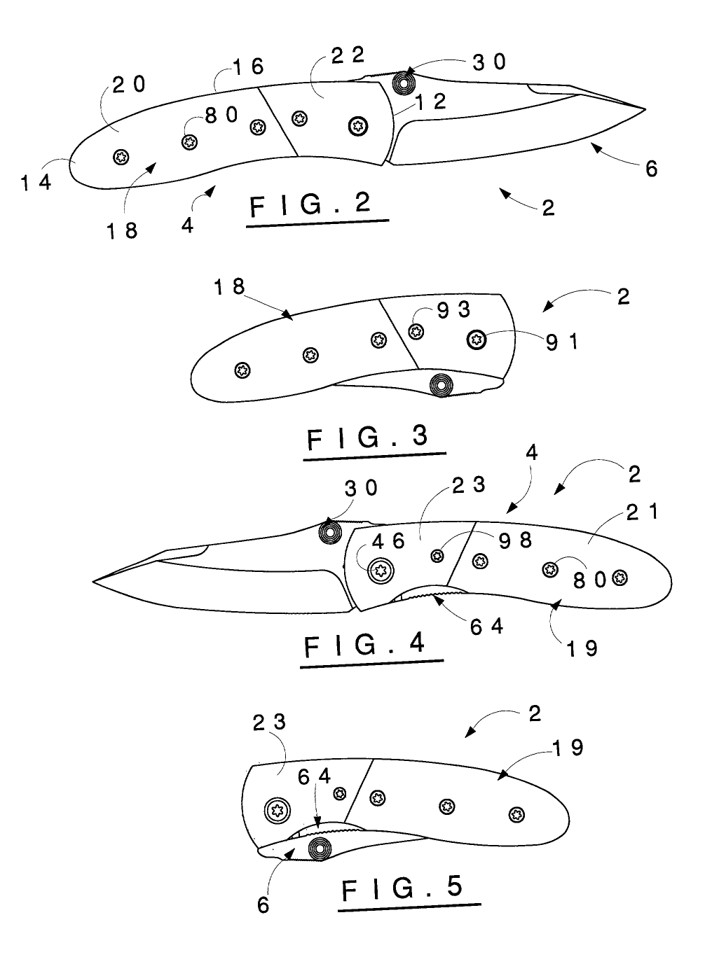

Referring in detail to the drawings, the invention provides a double action folding knife 2 comprising a longitudinal sheath handle 4, a blade 6 that pivots about one end from a sheathed position within the handle (see FIG. 3) to a use position external of the handle (see FIG. 2), spring means 8, defined in part by free end 9, to rotate the blade from the sheathed position into the use position and hidden trigger means 10 for automatic movement of the blade from the sheathed position to lock in the use position.

Spring means 8 is cocked by manual rotation of the blade 6 from the use position of FIG. 2 to the sheathed position of FIG. 3 and is un-cocked by manipulation of trigger means 10 to produce automatic rotation of the blade from the sheathed position to the use position

Referring to FIG. 2, the longitudinal sheath handle 4 has a first end 12, a second end 14 and a channeled body portion 16 integrally joining these ends. The left side 18 of the sheath handle 4 comprises left scale 20 and left bolster 22.

Referring to FIG. 4, the right side 19 of sheath handle 4 comprises right scale 21 and right bolster 23.

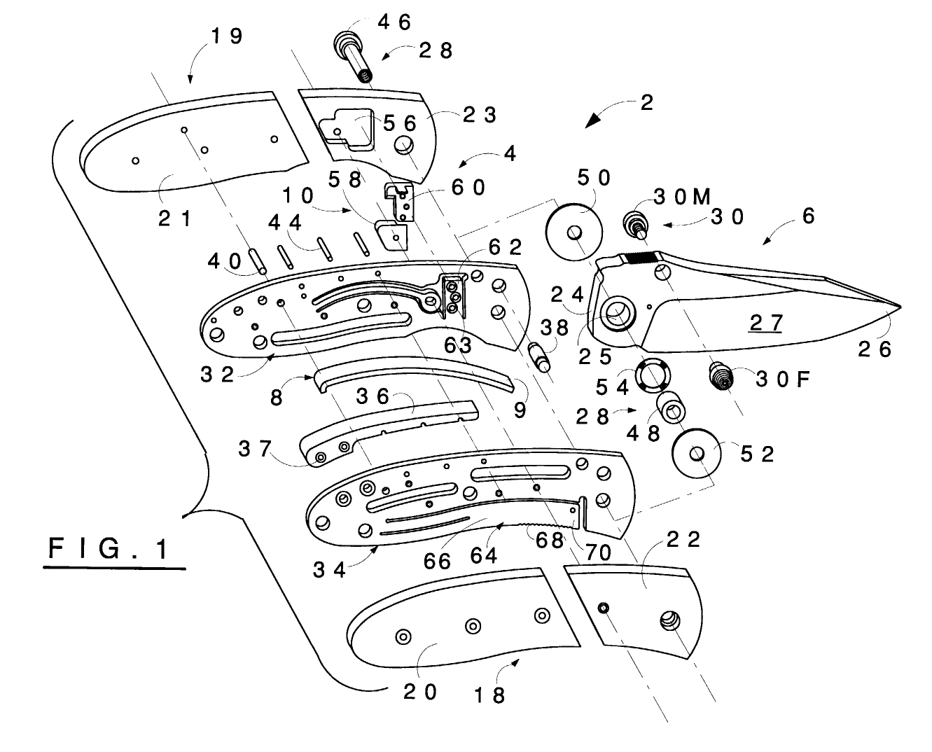

Referring to FIGS. 1,2 & 4, the blade 6 has a pivot end 24 containing a pivot bore 25, a free end 26 and an integral central body portion 27 all lying in a common plane. The pivot end 24 is pivoted to the handle first end 12 via pivot means 28 about an axis normal to the common plane enabling the blade 6 to be moved manually by a stud 30 between the sheathed position within the handle through an arc to the use position external of the handle 4. The stud 30 comprises the male part 30M and female part 30F.

In addition to small screws and like fasteners (not shown), the double action folding knife 2 includes a right liner 32, left liner 34, a spacer spine 36, a blade stop pin 38, a spring retainer pin 40 and a plurality of spine pins 44. The spacer spine 36 includes counter-sunk bores 37 to receive screws (not shown) that sandwich it between the right liner 32 and left liner 34. Typically, the liners are formed from 1/16^{th} stainless steel sheet and the fasterners are torx head type.

The pivot means 28 comprises blade pin 46, blade bushing 48, large washer 50, small washer 52 and compression washer 54.

The trigger means 10 comprises a cavity 56 in the right hand bolster 23, the catch 58, sear 60 and a lug part 62 of the right liner 32. The sear 60 includes threaded bores 61 and lug part 62 has counter-sunk bores 63 though which screws (not shown) extend to fasten sear 60 to lug part 62. The catch 58 has a beveled portion 59 that engages a mating beveled portion 65 on sear 60 to function in cocking and un-cocking of the leaf spring 8. Further, the sear 60 has a lateral extending nib 67 that also functions in cocking and un-cocking of the leaf spring 8.

Lock means 64, that is part of left hand liner 34 and automatically locks the blade 6 in the use position upon completion of the movement thereof into such position and manually unlocks it for manual return to the sheathed position, comprises tongue 66 that is a cantilevered integral part of the left hand liner 34 and has a notched edge 68. Tongue 66 is bent so that its end 70 protrudes slightly above the plane of the liner 34 providing the lock means 64 with a spring action.

Left liner 34 (see FIGS. 14 & 15) further comprises bore 72 to receive spring retainer pin 40, a plurality of larger bores 74, a plurality of smaller bores 76, a pair of counter-bored bores 77, slots 78 and a plurality of threaded bores 79 that serve, inter alia, to receive bolts 80 that fix the left hand scale 20 to the handle 4.

Right liner 32, (see FIGS. 16 & 17), in addition to the lug part 62 mentioned above, comprises trigger spring 82, a plurality of larger bores 74, a plurality of smaller bores 76, a pair of counter-bored bores 77 and a slot 84.

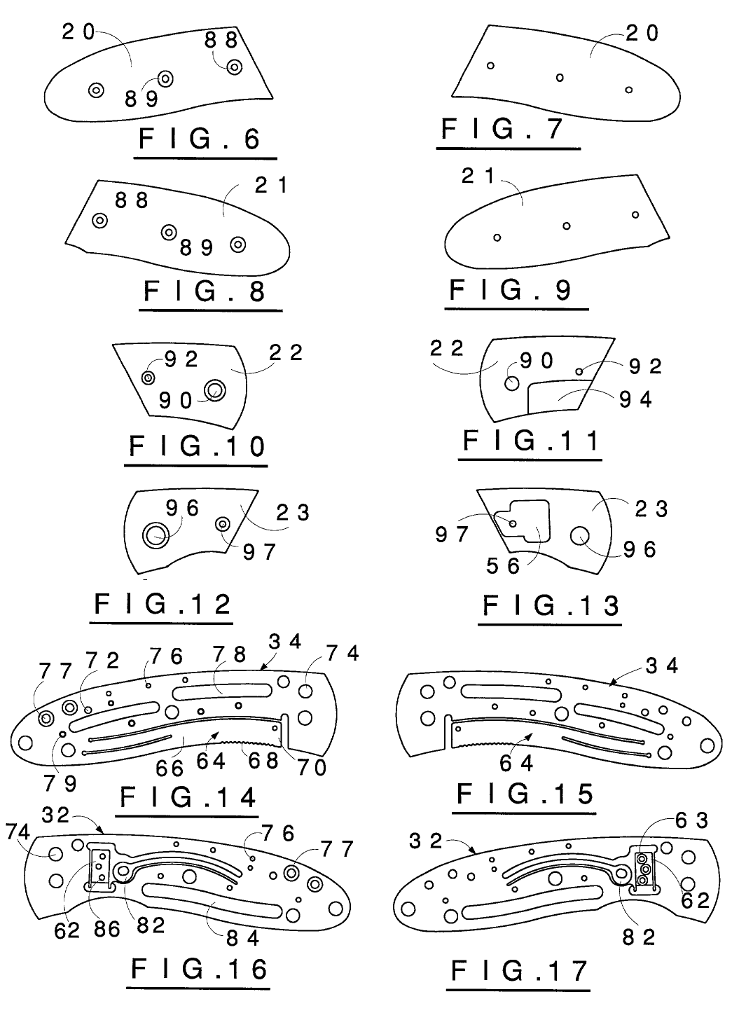

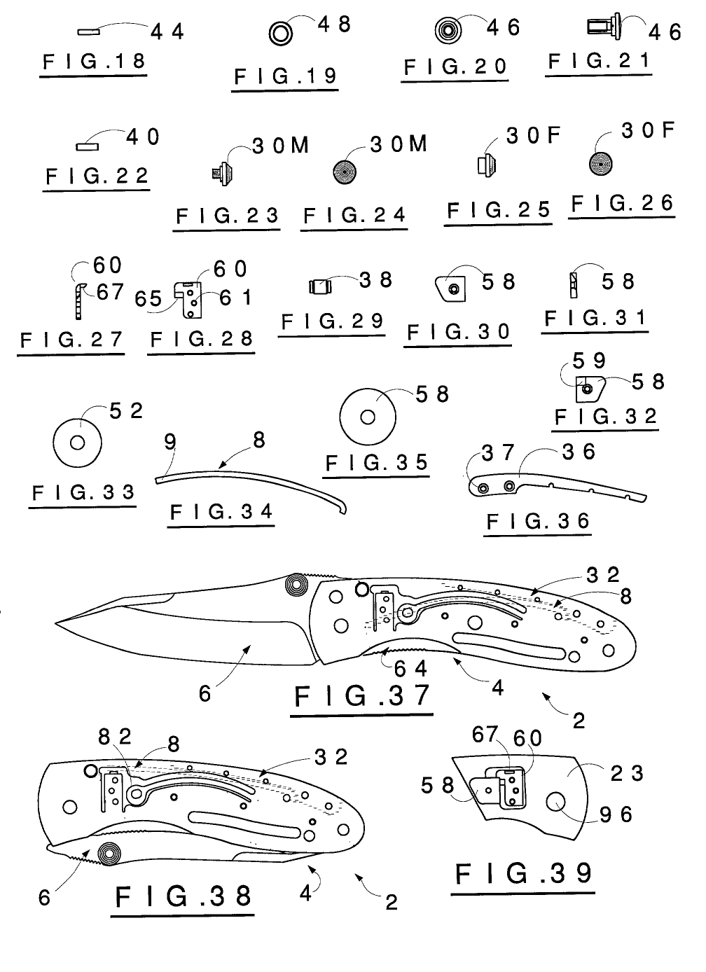

Referring to FIGS. 6-7, the left scale 20 contains bores 88 with counter-bores 89 to receive bolts 80 (FIG. 2).

Referring to FIGS. 8-9, the right scale 21 contains bores 88 with counter-bores 89 to receive bolts 80 (FIG. 4).

Referring to FIGS. 10-11, the left bolster 22 contains counter-bored bore 90 to receive the male end 91 of pivot means 28, a counter-bored bore 92 to receive screw 93 (FIG. 3) and a cavity 94 in its inside surface.

Referring to FIGS. 12-12, the right bolster 23 contains a counter-bored bore 96 to receive the blade pin 46, a counter-bored bore 97 to receive screw 98 (FIG. 4) and the cavity 56 that chambers parts of the trigger means 10 (FIGS. 1& 37).

The handling of the new knives of the invention can be explained by reference to the drawings, particularly FIGS. 37-39.

Obviously, the knife 2 is stowed in a pocket, on a belt, etc. with the blade 6 in the sheathed position (FIGS. 5 & 38). Since the knife 2 is of the double action type, the knife user (not shown) has two choices as to how to open the blade 6 into the use position (FIG. 37). As a first way, the user may open the blade silently by grasping the stud 30 to pull the blade 6 out of the handle 4 until stopped by engagement of the blade pivot end 24 with the stop pin 38. When the blade 6 reaches such stop position, end 70 of the lock mean 64 will spring behind the pivot end 24 to lock the blade 6 into its use position. During this mode of manual movement of the blade to the use position, the leaf spring 8 is retained in its cocked position by nib 67 of the sear 60 (FIG. 38).

When the user has finished use of the knife 2, the blade 6 is returned to the sheathed position by pressing inwardly on the lock means 64, which is accessible at the side of the bolster 23 as seen in FIG. 5. This unlocks the blade 6 from retention in its use position to enable manual folding of the blade back into the handle 4. During all this procedure, the leaf spring means 8 remains in the cocked position shown in phantom in FIG. 38.

In a second way, the user may open the blade automatically by using the trigger means 10. To do this, the user places the closed knife 2 with the right hand side up first end 12 forward (FIG. 5) in his right hand and with his thumb presses against the side of bolster 23 to move it sideways into the position shown in phantom line in FIG. 5. This movement of bolster 23 causes the nib 67 of sear 60 to disengage the forward end 9 of leaf spring 8 thereby enabling the spring 8 to un-cock causing the blade 6 quickly to jump from the sheathed position (FIG. 38) to the use position while to spring 8 moves into its un-cocked position (FIG. 37). At the same time, lock means 64 will move as described above to lock the blade 6 in its use position.

When the user has finished use of the knife 2 after applying the trigger means method of blade deployment, the blade 6 is returned to its sheathed position in the same way as described above. However in this case, the un-cocked spring 8 will be forced by the pressure applied to the blade 6 by the user to move into its cocked position (FIG. 38) where nib 67 of sear 60 will slip beneath its free end 9 to maintain the spring means 8 cocked for subsequent release by the trigger means 10.

1. A double action folding knife comprising:
a longitudinal sheath handle,
a blade that pivots about one end from a sheathed position within said handle to a use position external of said handle,
spring means to rotate said blade from said sheathed position into said use position,
lock means to lock said blade in said use position and
hidden trigger means to cause said spring means to move said blade from said sheathed position to lock in said use position.

2. In a double action folding knife including a longitudinal sheath handle, a blade that pivots about one end from a sheathed position within said handle to a use position external of said handle and spring means to rotate said blade from said sheathed position into said use position, the improvement characterized by:
hidden trigger means to release said spring means for said rotation of said blade from said sheathed position to said use position.

3. A double action folding knife comprising:
a longitudinal sheath handle including left and right scales and left and right bolsters,
a blade that pivots about one end from a sheathed position within said handle to a use position external of said handle,
spring means to rotate said blade from said sheathed position into said use position and
hidden trigger means that comprises said right bolster for automatic movement of said blade from said sheathed position to lock in said use position.

4. A double action folding knife comprising:
a longitudinal sheath handle defined by a first end, a second end and a channeled body portion integrally joining said first and second ends, said sheath handle including a right scale, a right bolster, a left scale, a left bolster, a right liner and a left liner,
a blade defined by a pivot end, a free end and an integral central body portion all lying in a common plane, said pivot end being pivoted to said handle first end about an axis normal to said common plane enabling said blade to move between a sheathed position within said handle through an arc to a use position external of said handle,
pivot means upon which said blade is pivoted enabling said blade to be manually moved between said sheathed position and said use position,
lock means to automatically lock said blade in said use position upon completion of said movement thereof into said use position and to be manually unlocked for manual return of said blade from said use position to said sheathed position,
spring means associated with said pivot means comprising a leaf spring that is cocked by manual rotation of said blade from said use position to said sheathed position and can be un-cocked for automatic rotation of said blade forcibly throughout movement from said sheathed position to said use position and
hidden trigger means comprising said right bolster to un-cock aid spring means for said rotation of said blade from said sheathed position to lock in said use position.

5. The double action folding knife of claim 4 wherein said hidden trigger means comprises said right bolster that is pivoted to reciprocate in a plane parallel to said common plane between a spring cocked position and a spring un-cocked position, a cavity in said right bolster, a catch fixed in said cavity and a sear that engages said spring means when said blade is returned to said sheathed position and disengages said spring means when said right bolster is moved into said spring un-cocked position.

6. The double action folding knife of claim 5 wherein said right liner includes a lug part upon which said sear is mounted.

7. The double action folding knife of claim 6 wherein said right liner includes an integral cantilevered trigger spring.

8. A double action folding knife comprising:
a longitudinal sheath handle defined by a first end, a second end and a channeled body portion integrally joining said first and second ends,
a blade defined by a pivot end, a free end and an integral central body portion all lying in a common plane, said pivot end being pivoted to said handle first end about an axis normal to said common plane enabling said blade to pivot between a sheathed position within said handle through an arc to a use position external of said handle,
a leaf spring that moves from a cocked position to an un-cocked position to power said movement of said blade through said arc,
lock means to automatically lock said blade in said use position upon completion of said movement thereof to said use position and to be manually unlocked for manual return of said blade from said use position to said sheathed position, and
hidden trigger means to release said leaf spring from said cocked position comprising a bolster pivoted to reciprocate in a plane parallel to said common plane between a spring cocked position and a spring un-cocked position, a cavity in the inner side of said bolster and a sear fitted in said cavity that engages said leaf spring when said blade is returned to said sheathed position and disengages said leaf spring when said bolster is moved into said spring un-cocked position.
